(19) United States
(12) Patent Application Publication
(10) Pub. No.: US 2015/0261631 A1
(43) Pub. Date: Sep. 17, 2015

(54) MEMORY SYSTEM AND MEMORY CONTROLLER

(71) Applicant: Kabushiki Kaisha Toshiba, Minato-ku (JP)

(72) Inventor: Junji KURIHARA, Yokohama-shi (JP)

(73) Assignee: Kabushiki Kaisha Toshiba, Minato-ku (JP)

(21) Appl. No.: 14/332,560

(22) Filed: Jul. 16, 2014

Related U.S. Application Data
(60) Provisional application No. 61/951,918, filed on Mar. 12, 2014.

(51) Int. Cl. G06F 11/20

(52) U.S. Cl. CPC G06F 11/2053

(57) ABSTRACT

According to one embodiment, a memory system includes a table management unit having a command information table, a data buffer configured to save second data obtained by dividing first data, a tag buffer configured to save a second tag corresponding to the second data and a data discarding unit configured to read the second data in the data buffer and transfer the read second data to a host. The memory system further includes a control unit configured to set the discard flag corresponding to the read command when an error occurs, and an entry processing unit configured to cause, when the table management unit acquires the second tag and a first discard flag of a first entry is set, the data discarding unit to discard third data, the first entry corresponding to the acquired second tag and being registered in the command information table.

### CROSS-REFERENCE TO RELATED APPLICATIONS

This application is based upon and claims the benefit of priority from U.S. Provisional Application No. 61/951,918, filed on Mar. 12, 2014; the entire contents of which are incorporated herein by reference.

### FIELD

Embodiments described herein relate generally to a memory system and a memory controller.

### BACKGROUND

In a memory system including a non-volatile storage unit, a process of transferring data read based on a read command may be suspended by an error for some reason. In this case, a controller of the memory system needs to search, for example, a plurality of buffers through which data read from the non-volatile storage unit passes in the controller for the data read based on the read command that the error has occurred, and to delete the data.

### BRIEF DESCRIPTION OF THE DRAWINGS

FIG. 1 is a diagram illustrating a configuration of a memory system according to one embodiment;

FIG. 2 is a diagram illustrating a configuration of a command information table according to a first embodiment;

FIG. 3 is a flowchart illustrating the operation when firmware receives a read command in the first embodiment;

FIG. 4 is a diagram illustrating a configuration of a command information table according to a second embodiment; and

FIG. 5 is a flowchart illustrating the operation when firmware receives a read command in the second embodiment.

### DETAILED DESCRIPTION

In general, according to one embodiment, a memory system includes: a non-volatile storage unit; a table management unit having a command information table which register a entry including a first tag and a discard flag, both of the first tag and the discard flag corresponding to a read command received from a host; a data buffer configured to save, in FIFO mode, second data obtained by dividing first data in predetermined units, the first data being read from the non-volatile storage unit based on the read command; a tag buffer configured to save, in FIFO mode, a second tag corresponding to the second data saved in the data buffer; and a data discarding unit configured to read the second data in the data buffer and transfer the read second data to the host. According to the embodiment, the memory system further includes: a control unit configured to set the discard flag corresponding to the read command when an error occurs during reading of data from the non-volatile storage unit based on the read command; and an entry processing unit configured to cause, when the table management unit acquires the second tag from the tag buffer and a first discard flag of a first entry is set, the data discarding unit to discard third data, the third data being data read from the data buffer and corresponding to the acquired second tag, the first entry corresponding to the acquired second tag and being registered in the command information table.

Exemplary embodiments of a memory system and a memory controller will be explained below in detail with reference to the accompanying drawings. The present invention is not limited to the following embodiments.

### First Embodiment

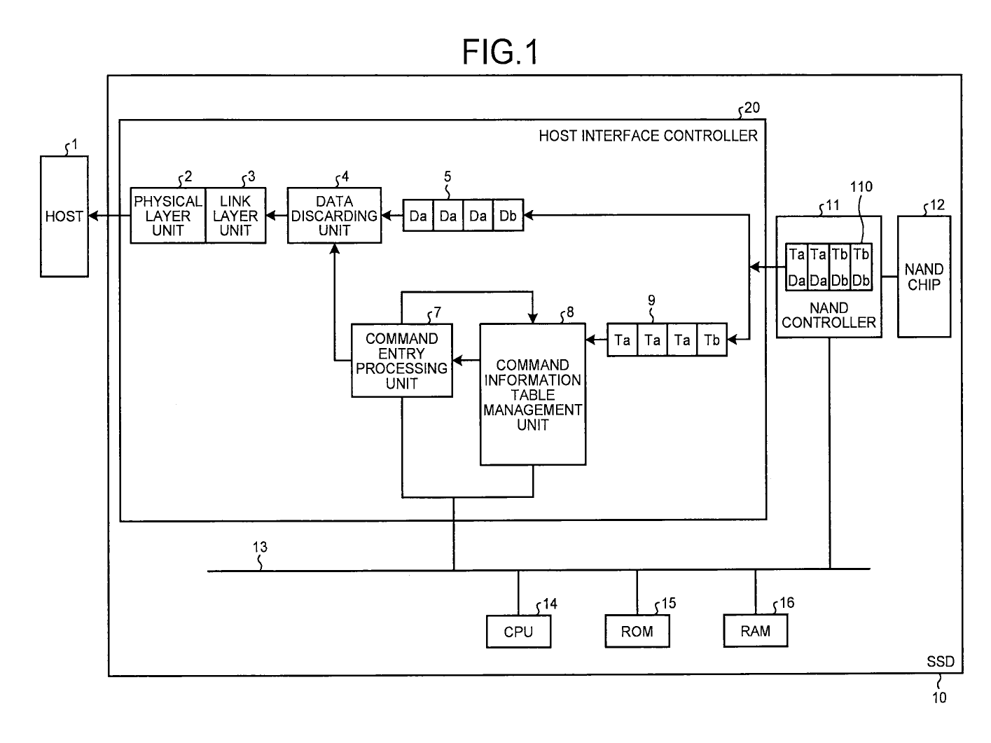

FIG. 1 is a diagram illustrating a configuration of a memory system 10 according to one embodiment. The memory system 10 is, for example, an SSD. The memory system 10 includes a host interface controller 20 that accepts a read command from a host 1 and transfers read data to the host 1, a NAND controller 11 that controls a NAND chip 12, the NAND chip 12, a CPU 14 (a control unit), a ROM 15, and a RAM 16. The host interface controller 20, the NAND controller 11, the CPU 14, the ROM 15, and the RAM 16 are connected to each other via a bus 13. The ROM 15 stores firmware executed by the CPU 14, and the like. For example, when power is supplied to the memory system 10, the CPU 14 reads the firmware stored in the ROM 15 into the RAM 16, and executes a predetermined process in accordance with the firmware. The RAM 16 is used as a work area of the CPU 14, and stores the firmware loaded from the ROM 15, and the like.

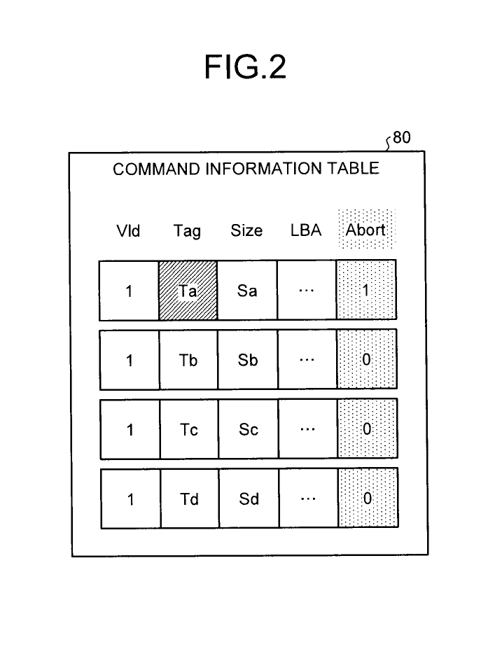

For example, the SAS standard specifies that both a read command and a tag are issued from the host 1. When receiving a read command from the host 1, the memory system 10 associates a tag (first tag) of the read command with LBA (Logical Block Addressing) being a start address of read data of the read command, Size being the data size of data that is yet to be transferred to the host 1 among the read data (the initial value is the whole data size of the read data by the read command), and an Abort (discard) flag described below (the initial value is “0”), and registers them as one entry in a command information table 80 illustrated in FIG. 2. Moreover, each entry contains “Vld (Valid)” (a valid flag) indicating whether or not the entry has already been processed (the initial value is “1” that indicates the process is not completed). The Abort flag is a binary flag provided to discard data read based on a read command that an error has occurred, the read command being described below. If the Abort flag is set (“1”), it means that the data is to be discarded. If the Abort flag is not set (“0”), it indicates that it is not necessary to discard data.

Read data read from the NAND chip 12, together with a tag of a read command corresponding to the read data, is divided into the units (internal units) specified in the NAND controller 11 in the NAND controller 11, and stored in an internal buffer 110. In other words, the data in the internal units, together with its corresponding tag, is stored in the internal buffer 110. The data in the internal units of the internal buffer 110 is sequentially transferred to the host interface controller 20. In other words, the read command, the tag, and the data in the Internal units are uniquely associated and transferred to the host interface controller 20.

The host interface controller 20 includes a data buffer 5, a data discarding unit 4, a link layer unit 3, and a physical layer unit 2. The data buffer 5 separates, from the tags, the data in the internal units transferred from the internal buffer 110, converts its data format, and stores the data in FIFO (First In, First Out) mode as the data divided into predetermined units (for example, frame units). The data discarding unit 4 discards the data in the predetermined units sent out from the data buffer 5 at the instruction of a command entry processing unit 7 described below. The link layer unit 3 converts the data in the predetermined units that has not been discarded by the data discarding unit 4 into data in a format specified in a link layer. The physical layer unit 2 converts the data sent out from the link layer unit 3 into data in a format of a physical layer, and transfers the data to the host 1.

The host interface controller 20 further includes a tag buffer 9, a command information table management unit 8, and the command entry processing unit 7. The tag buffer 9 stores the tags transferred with the data in the internal units from the NAND controller 11, in FIFO mode as tags (second tags), the number of which is the same as the number of pieces of the data in the predetermined units in the data buffer 5. In other words, the tag buffer 9 stores the same tags in such a manner as to have a one-to-one correspondence with pieces of the data in the predetermined units stored in the data buffer 5. Specifically, if three pieces of data “Da” in the predetermined units corresponding to a tag Ta are stored in the data buffer 5, three tags “Ta” are stored in the tag buffer 9 in accordance with “Da”. The command information table management unit 8 manages the command information table 80, illustrated in FIG. 2, that stores an entry listing information such as a tag and its corresponding Size, LBA, and the like. For example, if the memory system 10 receives a read command from the host 1, an entry corresponding to the read command is registered in the command information table management unit 8. When the entry is registered, the NAND controller 11 or the like initiates a read operation from the NAND chip 12. Furthermore, the command information table management unit 8 acquires the tag from the tag buffer 9. The command entry processing unit 7 has a buffer function that holds the information of the entry acquired from the command information table 80, using the tag buffered in the tag buffer 9. The command entry processing unit 7 knows the occurrence of an error such as an error occurring in the memory system 10 during error correction (ECC error) upon data readout, or a read stop instruction from the host 1, and applies a break described below upon the occurrence of the error.

When acquiring one tag Ta from the tag buffer 9, the command information table management unit 8 refers to the command information table 80 to transmit the information of an entry corresponding to the tag Ta to the command entry processing unit 7. If the Abort flag of the acquired entry is set (“1”), the command entry processing unit 7 causes the data discarding unit 4 to discard Da corresponding to the tag Ta of the acquired entry. The command entry processing unit 7 then causes the command information table management unit 8 to subtract a data size corresponding to the predetermined unit from Size of the relevant entry of the command information table 80. If the Abort flag of the acquired entry is “0”, the command entry processing unit 7 causes the data discarding unit 4 to pass Da corresponding to the tag Ta of the acquired entry through to the link layer unit 3. The command entry processing unit 7 then causes the command information table management unit 8 to subtract the data size corresponding to the predetermined unit from Size of the relevant entry of the command information table 80. When Size becomes “0”, it indicates that the process on the relevant entry is completed. Accordingly, “Vld” of the relevant entry becomes “0”. When acquiring one tag Ta from the tag buffer 9, the command information table management unit 8 refers to the command information table 80, and transmits the information of the entry corresponding to the tag Ta to the command entry processing unit 7. Accordingly, the entry held by the command entry processing unit 7 is overwritten whenever the command information table management unit 8 acquires one tag from the tag buffer 9.

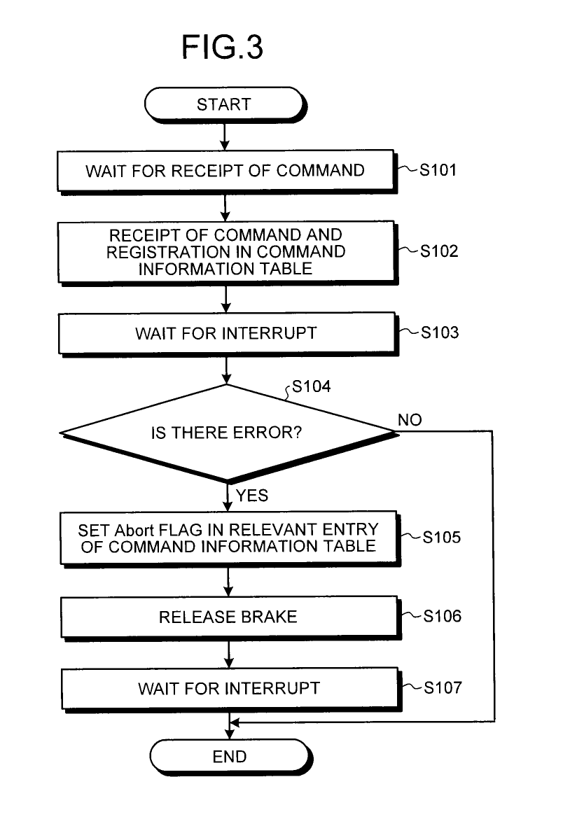

FIG. 3 illustrates a flowchart illustrating the operation when firmware receives a read command in the embodiment. Firstly, the firmware waits for the receipt of a read command (Step S101). When receiving a read command, the firmware associates a tag received together with the command with LBA and Size, and registers them as an entry of the command information table 80 in the command information table management unit 8 (Step S102). The entry contains the Abort flag. The initial value of the Abort flag is “0”. The registration allows the NAND controller 11 or the like to initiate the readout operation from the NAND chip 12. The firmware then waits for an interrupt from the command entry processing unit 7 as a completion notification with respect to the read command received in Step S101 (Step S103). The completion notification is notified triggered by a normal end of the read command or the occurrence of an error. The firmware checks the factor of the interrupt after receiving the completion notification. The normal end of the read command indicates the completion of the process on the entry corresponding to the read command.

The firmware subsequently determines the presence or absence of an error (Step S104). When the interrupt occurs, the firmware checks Size of the entry in the command information table 80, the entry corresponding to the read command received in Step S101. If Size is not “0”, the firmware determines that there is an error. In this manner, when an interrupt occurs, the firmware refers to information held in the command information table 80 and accordingly can determine the presence or absence of an error. The error is, for example, an error during error correction (ECC error) upon the above-mentioned readout, or a read stop instruction from the host 1. If it is determined that there is no error (Step S104: No), the process is caused to end. If the firmware determines that there is an error, the command entry processing unit 7 has already applied a brake to the process on the read data based on the above cause of the error independently of the operation of the firmware at the point when the firmware makes the determination of Step S104. Specifically, the process on the read data is the transfer of the data in predetermined units from the data buffer 5 to the data discarding unit 4. Applying a brake to the process on the read data is, for example, that the command entry processing unit 7 causes the data discarding unit 4 to stop data transfer to the link layer unit 3 and the command entry processing unit 7 stops the acquisition of the entry from the command information table 80. Specifically, methods for the command entry processing unit 7 causing the data discarding unit 4 to stop data transfer include a method for the command entry processing unit 7 passing a stop signal to the data discarding unit 4 and the data discarding unit 4, which has received the stop signal, stopping data transfer.

If an error has occurred (Step S104: Yes), the firmware sets “1” in the Abort flag of the command information table 80 (Step S105). The firmware then causes the command entry processing unit 7 to release the above-mentioned brake (Step S106). Releasing the brake is, for example, that the command entry processing unit 7 causes the data discarding unit 4 to resume data transfer to the link layer unit 3 and the command entry processing unit 7 resumes the acquisition of the entry from the command information table 80. When the firmware sets the Abort flag, the command entry processing unit 7 causes the data discarding unit 4 to discard the predetermined unit corresponding to the tag of the entry where the Abort flag is “1”. The brake is released in Step S106. Accordingly, the process on the read data can be resumed. The firmware subsequently waits for an interrupt from the command entry processing unit 7 as the completion notification to the read command received in Step S101 (Step S107), and ends the flow.

If the Abort flag and the data discarding unit 4 do not exist, and if an error occurs for some reason in the process of transferring data read based on a read command, it is necessary to search the data buffer 5, the tag buffer 9, and the internal buffer 110 for such data read based on a read command, install hardware to delete the data, and operate the firmware.

In contrast, the memory system according to the first embodiment, the Abort flag is provided to an entry of the command information table 80, and the data discarding unit 4 is provided in the host interface controller 20. Accordingly, it becomes possible to handle an error. Therefore, it is possible to obtain the effect of enabling the simplification of the implementation of hardware and firmware.

### Second Embodiment

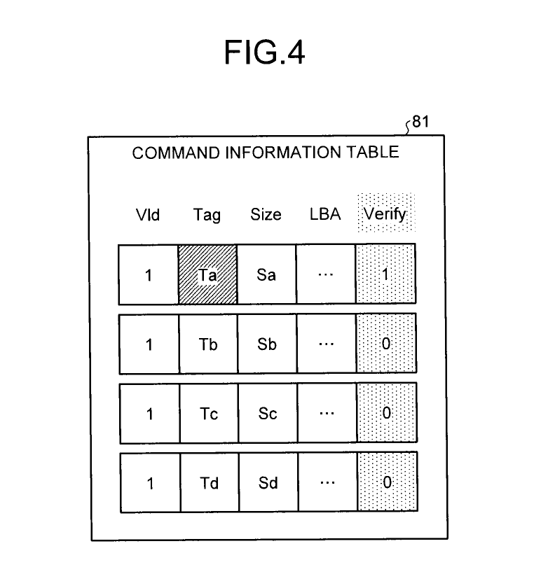

A memory system in compliance with the SAS or SCSI standard supports a Verify command. The Verify command is a command, issued by the host 1, that checks whether or not data stored in the NAND chip 12 has been destroyed, using a checksum or the like. In order to support the Verify command, a command information table managed by the command information table management unit 8 includes entries each containing a Verify flag indicating the process result of the Verify command as in a command information table 81 illustrated in FIG. 4.

The configuration of the memory system according to the embodiment is the same as the configuration of the memory system 10 of the first embodiment illustrated in FIG. 1. The second embodiment is different from the first embodiment in that each entry of the command information table 81 managed by the command information table management unit 8 contains the Verify flag as illustrated in FIG. 4. Moreover, the memory system 10 according to the embodiment supports the Verify command and accordingly is provided with the data discarding unit 4 in the host interface controller 20 to discard data corresponding to an entry in which the Verify flag is “1” upon reading of the data.

In the first embodiment, the Abort flag is newly provided as the discard flag. In this embodiment, however, the Verify flag is used as the discard flag. When acquiring one tag Ta from the tag buffer 9, the command information table management unit 8 refers to the command information table 81 and transmits the information of an entry corresponding to the tag Ta to the command entry processing unit 7. If the Verify flag of the acquired entry is set (“1”), the command entry processing unit 7 causes the data discarding unit 4 to discard Da corresponding to the tag Ta of the acquired entry. The command entry processing unit 7 then causes the command information table management unit 8 to subtract a data size corresponding to the predetermined unit from Size of the relevant entry of the command information table 81. If the Verify flag of the acquired entry is “0”, the command entry processing unit 7 causes the data discarding unit 4 to pass Da corresponding to the tag Ta of the acquired entry through to the link layer unit 3. The command entry processing unit 7 then causes the command information table management unit 8 to subtract the data size corresponding to the predetermined unit from Size of the relevant entry of the command information table 81. When Size becomes “0”, “Vld” of the entry becomes “0”. When acquiring one tag Ta from the tag buffer 9, the command information table management unit 8 refers to the command information table 81, and transmits the information of the entry corresponding to the tag Ta to the command entry processing unit 7. Accordingly, the entry held by the command entry processing unit 7 is overwritten whenever the command information table management unit 8 acquires one tag from the tag buffer 9.

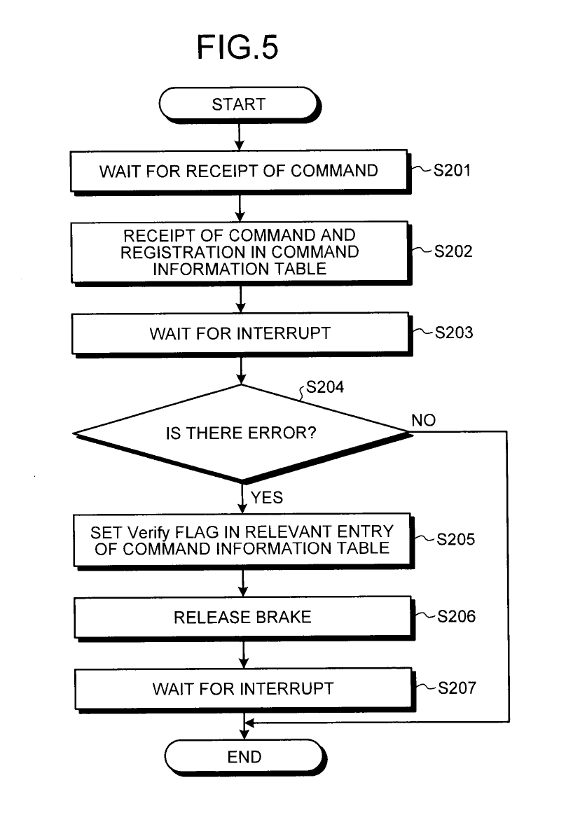

FIG. 5 illustrates a flowchart illustrating the operation when the firmware receives a read command in the embodiment. Firstly, the firmware waits for the receipt of a read command (Step S201). When receiving a read command, the firmware associates a tag received together with the command with LBA and Size, and registers them as an entry of the command information table 81 in the command information table management unit 8 (Step S202). The entry contains the Verify flag. The initial value of the Verify flag is “0”. The registration allows the NAND controller 11 or the like to initiate the readout operation from the NAND chip 12. The firmware then waits for an interrupt from the command entry processing unit 7 as a completion notification with respect to the read command received in Step S201 (Step S203). The completion notification is notified triggered by a normal end of the read command or the occurrence of an error. The firmware checks the factor of the interrupt after receiving the completion notification.

The firmware subsequently determines the presence or absence of an error (Step S204). When the interrupt occurs, the firmware checks Size of the entry in the command information table 81, the entry corresponding to the read command received in Step S201. If Size is not “0”, the firmware determines that there is an error. In this manner, when an interrupt occurs, the firmware refers to information held in the command information table 81 and accordingly can determine the presence or absence of an error. If it is determined that there is no error (Step S204: No), the process is caused to end. If the firmware determines that there is an error, the command entry processing unit 7 has already applied a brake to the process on the read data separately from the operation of the firmware at the point when the firmware makes the determination of Step S204. The meaning of the break is the same as the first embodiment.

If an error has occurred (Step S204: Yes), the firmware sets “1” in the Verify flag of the command information table 81 (Step S205). The firmware then causes the command entry processing unit 7 to release the above-mentioned brake (Step S206). Releasing the brake is, for example, that the command entry processing unit 7 causes the data discarding unit 4 to resume data transfer to the link layer unit 3 and the command entry processing unit 7 resumes the acquisition of the entry from the command information table 81. When the firmware sets the Verify flag, the command entry processing unit 7 causes the data discarding unit 4 to discard the predetermined unit corresponding to the tag of the entry where the verify flag is “1”. The brake is released in Step S206. Accordingly, the process on the read data can be resumed. The firmware subsequently waits for an interrupt from the command entry processing unit 7 as the completion notification to the read command received in Step S201 (Step S207), and ends the flow.

According to the second embodiment, the memory system of the SAS or SCSI standard can handle an error by simply using the existing function for supporting the Verify command. Accordingly, it is possible to obtain the effect of enabling the dramatic simplification of the implementation of hardware and firmware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a non-volatile storage unit;
a table management unit including a command information table which register a entry including a first tag and a discard flag, both of the first tag and the discard flag corresponding to a read command received from a host;
a data buffer configured to save, in FIFO mode, second data obtained by dividing first data in predetermined units, the first data being read from the non-volatile storage unit based on the read command;
a tag buffer configured to save, in FIFO mode, a second tag corresponding to the second data saved in the data buffer;
a data discarding unit configured to read the second data in the data buffer and transfer the read second data to the host;
a control unit configured to set the discard flag corresponding to the read command when an error occurs during reading of data from the non-volatile storage unit based on the read command; and
an entry processing unit configured to cause, when the table management unit acquires the second tag from the tag buffer and a first discard flag of a first entry is set, the data discarding unit to discard third data, the third data being data read from the data buffer and corresponding to the acquired second tag, the first entry corresponding to the acquired second tag and being registered in the command information table.

2. The memory system according to claim 1, wherein when the error occurs, the entry processing unit causes the data discarding unit to stop the transfer of the second data, and causes the table management unit to stop the acquisition of the second tag from the buffer.

3. The memory system according to claim 2, wherein after the control unit set the discard flag, the control unit permits the entry processing unit to cause the data discarding unit to resume the transmission of the second data.

4. The memory system according to claim 1, wherein
the discard flag is a Verify flag indicating the process result of a Verify command.

5. The memory system according to claim 4, wherein
the Verify command is sent from the host and based on a SCSI standard.

6. The memory system according to claim 4, wherein
the Verify command is sent from the host and based on a SAS standard.

7. The memory system according to claim 1, wherein
the entry includes a size of untransferred data, the untransferred data being to be transferred to the host based on the read command corresponding to the entry, and
the entry processing unit causes the table management unit to subtract the predetermined unit from the size included in the entry when the table management unit acquires the second tag from the tag buffer.

8. The memory system according to claim 1, wherein the error is an error caused by error correction or the receipt of a read stop instruction command from the host.

9. The memory system according to claim 1, further comprising an internal buffer configured to save, in FIFO mode, the first data together with a forth tag, the forth tag corresponding to the read command, wherein
the data buffer receives the first data from the internal buffer, and
the tag buffer receives a forth tag from the internal buffer.

10. The memory system according to claim 1, further comprising:
a link layer unit; and
a physical layer unit, wherein
the second data transferred from the data discarding unit is converted into data in a format of a link layer in the link layer unit, converted into data in a format of a physical layer in the physical layer unit, and transmitted to the host.

11. A memory controller comprising:
a table management unit including a command information table which register a entry including a first tag and a discard flag, both of the first tag and the discard flag corresponding to a read command received from a host;
a data buffer configured to save, in FIFO mode, second data obtained by dividing first data in predetermined units, the first data being read from a non-volatile storage unit based on the read command;
a tag buffer configured to save, in FIFO mode, a second tag corresponding to the second data saved in the data buffer;
a data discarding unit configured to read the second data in the data buffer and transfer the read second data to the host;
a control unit configured to set the discard flag corresponding to the read command when an error occurs during reading of data from the non-volatile storage unit based on the read command; and
an entry processing unit configured to cause, when the table management unit acquires the second tag from the tag buffer and a first discard flag of a first entry is set, the data discarding unit to discard third data, the third data being data read from the data buffer and corresponding to the acquired second tag, the first entry corresponding to the acquired second tag and being registered in the command information table.

12. The memory controller according to claim 11, wherein when the error occurs, the entry processing unit causes the data discarding unit to stop the transfer of the second data, and causes the table management unit to stop the acquisition of the second tag from the buffer.

13. The memory controller according to claim 12, wherein after the control unit set the discard flag, the control unit permits the entry processing unit to cause the data discarding unit to resume the transmission of the second data.

14. The memory controller according to claim 11, wherein
the discard flag is a Verify flag indicating the process result of a Verify command.

15. The memory controller according to claim 14, wherein
the Verify command is sent from the host and based on a SCSI standard.

16. The memory controller according to claim 14, wherein
the Verify command is sent from the host and based on a SAS standard.

17. The memory controller according to claim 11, wherein
the entry includes a size of untransferred data, the untransferred data being to be transferred to the host based on the read command corresponding to the entry, and
the entry processing unit causes the table management unit to subtract the predetermined unit from the size included in the entry when the table management unit acquires the second tag from the tag buffer.

18. The memory controller according to claim 11, wherein the error is an error caused by error correction or the receipt of a read stop instruction command from the host.

19. The memory controller according to claim 11, further comprising an internal buffer configured to save, in FIFO mode, the first data together with a forth tag, the forth tag corresponding to the read command, wherein
the data buffer receives the first data from the internal buffer, and
the tag buffer receives a forth tag from the internal buffer.

20. The memory controller according to claim 11, further comprising:
a link layer unit; and
a physical layer unit, wherein
the second data transferred from the data discarding unit is converted into data in a format of a link layer in the link layer unit, converted into data in a format of a physical layer in the physical layer unit, and transmitted to the host.
